(19) United States
(12) Patent Application Publication
(10) Pub. No.: US 2024/0405990 A1
(43) Pub. Date: Dec. 5, 2024

(54) COMPUTER-IMPLEMENTED METHOD AND SYSTEM FOR VERIFYING TOKENS ON A BLOCKCHAIN

(71) Applicants: Steven Patrick COUGHLAN, London (GB); Owen VAUGHAN, London (GB)

(72) Inventors: Steven Patrick COUGHLAN, London (GB); Owen VAUGHAN, London (GB)

(21) Appl. No.: 18/567,719

(22) PCT Filed: May 9, 2022
(86) PCT No.: PCT/EP2022/062395

§ 371 Date: Dec. 6, 2023

(30) Foreign Application Priority Data
Jun. 9, 2021 (GB) 2108255.7

(51) Int. Cl. H04L 9/32

(52) U.S. Cl. CPC H04L 9/3213; H04L 9/3247

(57) ABSTRACT

Embodiments provide improved solutions for verifying one or more tokens provided via a token transaction on a blockchain. The token transaction is generated by an issuer and forms a link in a chain of token transactions which can be traced back to a minting transaction that was used by the issuer to generate the token(s). At least one certification element is provided in one or more token transactions within the chain, wherein the certification element certifies the authenticity of the token(s) by or on behalf of the issuer. A validating entity need only traverse the token's history chain back to a transaction which comprises a certification element rather than back to the mint transaction. Additionally, or alternatively, the disclosure provides improved solutions for melting and reminting the token when a pre-determined threshold, limit or specified value has been reached. Melting and reminting may comprise issuance on the blockchain of a new mint transaction subsequent to the original mint transaction in the token's chain of history, or replacement of an issuer-associated component such as an identifier which serves thereafter to identify the token, the issuer and/or the new or original mint transaction.

### CROSS REFERENCE TO RELATED APPLICATIONS

This application is the U.S. National Stage of International Application No. PCT/EP2022/062395 filed on May 9, 2022, which claims the benefit of United Kingdom Patent Application No. 2108255.7, filed on Jun. 9, 2021, the contents of which are incorporated herein by reference in their entireties.

### TECHNICAL FIELD

The present disclosure relates to methods and systems for validating, issuing, updating, replacing or otherwise processing blockchain-based tokens that are implemented using token transactions. A token transaction is a blockchain transaction that comprises one or more token outputs. Embodiments of the disclosure are particularly suited for use in relation to systems in which tokenised assets need to be verified to confirm their legitimacy and issuance by an authorised party. Embodiments provide numerous technical advantages including, but not limited to, improved efficiencies, reduced processing requirements and increased security of blockchain-based transfers.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example, blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node that successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

### SUMMARY

As explained above, portions of cryptocurrency (tokens) are included in blockchain transactions as part of the underlying transfer mechanism specified by the blockchain's protocol. However, blockchain transactions can also be used to transfer ownership or control of other, additional assets which are tokenised and represented on the ledger. Embodiments of the present disclosure relate to the processing of these additional tokens, rather than the protocol-level cryptocurrency required by the blockchain network's protocol.

Using the blockchain to issue and spend tokens in of and itself is not novel. Known approaches have included the issuance of tokens using transaction outputs e.g. using an OP_RETURN or OP_FALSE OP_RETURN commands, in a UTXO-based approach in which tokens are coupled to transaction outpoints. Being more aligned with the native blockchain system, UTXO-based token systems share some advantageous features of the blockchain system in addition to the security such as in-script smart contracts for tokens. It also allows token issuers to peg their token value to the native blockchain token value.

Whichever tokenisation approach is adopted, however, there is a need to validate the tokens that have been issued to verify that they have been generated by an authorised issuing entity. The need to validate a given token can arise for various reasons. For example, receiving parties will wish to ensure that the token(s) they receive are genuine. This typically involves tracing a token's transactional history back to its originating (minting) transaction to be able to compare and validate a portion of minting data known to originate from the token issuer with data provided in the token transaction.

However, a technical challenge arises in some situations where a token's chain of history has grown over time to such an extent that tracing its history on the blockchain back to a minting transaction becomes expensive in terms of time and also the amount of processing resources required. Inefficiencies can therefore build over a token's lifetime as a result of its usage to the point where, in certain conditions, a token's history can become so extensive that it renders continued use of the token impractical and too costly in terms of resources.

When this occurs, the issuer may choose to destroy the token or withdraw it from use in its current form and may re-issue it. This process can be re-referred to as a “melt and re-mint” operation as it is analogous to the concept of melting down a traditional coin in a fiat currency system when it has become compromised or damaged in some way over time. To keep a required number of coins in circulation, a newly minted replacement can be issued by the minting authority. Clearly, the need to melt and remint incurs costs and requires resources for the issuing authority, and so it is disadvantageous to have to perform this operation on a frequent basis.

As known in the art, layer-1 blockchain tokens embed the token validation rules in script. These can be designed in such a way that the script proves the validity of a token all the way back through the chain of transaction until issuance. This is achieved by creating a hash puzzle that requires the previous transaction to be inserted as a solution (the transaction ID is the hash digest, and the transaction itself is the hash preimage). However, since each token transaction necessarily contains all of the data of the previous transaction, by induction it must contain all previous transactions back to issuance. This means that the size of each token transaction increases cumulatively, meaning that the latest transaction in the chain may be very large. This increased transaction size therefore increases the resource demands relating to bandwidth and storage requirements and the cost of writing to the ledger.

Therefore, for at least these reasons, it is desirable to provide enhanced efficiencies for validation and issuance of tokens on a blockchain, without compromising any of the security features implemented by the tokenisation protocol or the underlying blockchain protocol.

In accordance with one aspect of the present disclosure, a computer-implemented method is provided which may be defined as, at least, a method of validating, certifying and/or endorsing/attesting the authenticity a blockchain-implemented token. “Certification” may be understood herein to include: a stamp of legitimacy or authenticity, a proof of origin or provenance, and/or a confirmation of authorship/creation by a specific entity. “Validating” may be understood to include: checking, testing and/or confirming the legitimacy, authenticity, origin, authorship, certification or provenance of a blockchain-implemented token. In some embodiments, the token may be formed and/or processed in accordance with a “layer 1 token” protocol in which token validation rules are embedded within a script of the token transaction.

Embodiments of the disclosure enable blockchain-based tokens to be validated quickly and efficiently, and without the need to trace the token's provenance back to its origin on the blockchain. This provides significantly enhanced efficiencies and the requirement of fewer resources on behalf of parties who process the tokens (e.g. senders, receivers, issuers) as they do not need to traverse and process extensive token histories. Fewer resources are also consumed due to a reduced need to replace such tokens, or at least a reduction in the frequency of doing so. Moreover, embodiments of the disclosure, by either melting-and-reminting or stamping the tokens, enable a reset of the size of the latest transaction in the token transaction chain. Therefore, very large savings of transaction size are achieved. This is turn leads to a reduced bandwidth requirement, storage requirement, and cost of writing to the ledger.

The method comprises the step of adding a certification element to a token transaction that is an element in a chain of token transactions. The term “token transaction” may include a blockchain transaction which comprises at least one token, wherein the token represents a tokenised asset of any form and stored on or off chain, and the token is formed in accordance with a tokenisation protocol which is distinct from but implemented on top of the underlying blockchain protocol that is operated by the network nodes.

The chain of token transactions originates from a minting transaction which is used by the issuer, or by an authorised party on behalf of the issuer, to generate the token. Each token transaction, starting from the minting transaction onwards, passes the token on to the next element (token transaction) in the chain. Therefore, the token has a traceable and immutable, unbroken history on the blockchain ledger in the form of token transactions back to its mint transaction. Certain token transactions along that chain of history comprise a certification element. Advantageously, this removes or at least alleviates the need to trace the token's history all the way back to its originating (minting) transaction for verification/certification purposes as the verifier need only follow the history back to the last token transaction in the chain which contains a trusted certification element.

At least one, some or all of the token transactions in the chain comprise a certification element which serves as a verifiable mark, certificate or stamp of authenticity associated directly or indirectly with an authorised entity e.g. the token issuer or some other party that is trusted as an authorised or approved certification entity that can attest to the origin and/or legitimacy of the token on the issuer's behalf. In accordance with alternative wordings, the certification element may be referred to as a stamp or confirmation of authenticity.

The certification element may provide proof of knowledge of a secret that is known to be associated with or controlled by the issuer. In a preferred embodiment, one or some but not all of the token transactions in the chain may comprise a certification element. This provides the advantage of being more efficient because of the processing costs associated with provision of the certification element within the token transactions. (Hereafter, the term “issuer” may include other parties which are authorised by the issuer to act on their behalf).

In some embodiments, the same certification element may be provided in a plurality of token transactions within the chain. In other embodiments, however, a different certification element may be provided for each or some of the selected token transactions. Importantly, though, whether the same or different certification elements are used in the token transactions, the certification element(s) serve the purposes described above for facilitating attestation of the origin of the token.

In one or more embodiments, the certification element might take the form of cryptographic data such as a cryptographic element that can be provably associated with, or authorised by, the issuing entity. This could be, for example, a cryptographic key or a message signed using a key that is known to be associated by the issuer. The skilled person will readily understand that the certification element can take any suitable form which enables a verifying entity to establish that it has been provided and/or authorised by the issuer and that its provision in the token transaction serves as proof or evidence of the token's provenance, legitimacy and/or authenticity.

In one or more embodiments, the certification element may be added to the token transaction in accordance with at least one predetermined rule or criteria such as, for example, when the token has been spent (transferred) a pre-determined number of times. The criteria or rule may be determined by the issuer, a token owner/receiver/controller, or some other party. In other embodiments, the certification element may be added to a token transaction in the chain in response to a request, instruction or other signal. In this latter scenario, the insertion of the certification element may be performed on a more ad hoc basis rather than in a prescriptive manner.

In one or more embodiments where a predetermined rule or criteria is used to control or influence which token transaction(s) the certification element is added to within the chain, the certification element may be included in the chain at a predetermined interval such as every 100 transactions, or after a specified period of time such as each day or week (assuming, in this case, that the token will be involved in a sufficiently high frequency of transactional activity). Other criteria and rules may be utilised, but in essence certain embodiments of the disclosure comprise the use of one or more predetermined metrics or which specify which elements of the chain (transactions) the certification element is to be added to.

In one or more embodiments, the certification element can be added to a token transaction in any suitable manner known in the art. For example, in some protocols this may be after an OP_RETURN while in others it may be in a script which includes OP_FALSE OP_RETURN commands. In other embodiments, the certification element may be provided in a locking script of an output in the token transaction, and/or provided as metadata. The skilled person will readily understand that the certification element can be provided in association with the token transaction in a variety of ways and at a variety of locations within the transaction to provide the same advantageous effect.

In accordance with another aspect of the disclosure, there is provided a computer-implemented method of providing a blockchain-implemented token. In order to alleviate issues relating to lengthy history chains, an issuer may melt and re-mint one or more tokens provided in a token transaction, so that the token's prior history remains on-chain as a verifiable and auditable record of original provenance and authenticity, but the new mint transaction takes the place of the original mint transaction for verification purposes. To reduce the amount of processing resources required by the melt and re-mint process, this can be performed at periodic intervals so that the effort required to trace back to a minting transaction is reduced for the verifying party but the overheads associated with melting and reminting are also minimised for the issuer/certifying party.

The frequency at which the melt and re-mint process is performed can be predetermined according to at least one rule, criteria or metric, which can be evaluated by an automated resource such as a bot, oracle or other software component. For example, the tokens may be re-issued once a specified threshold, limit or measurable/quantifiable value has been reached. This may be the number of transactions written to the token's history chain on the blockchain since the original or last mint transaction, or every x number of token transactions written to the chain, or at periodic time intervals etc. This provides the advantage of predictability for token users and/or owners. Alternatively, the melt and re-mint process can be performed on an ad hoc or random/pseudo random basis.

The disclosure is not limited with regard to the particular mechanism used for melting and re-minting the tokens. In one embodiment, for example, an identifier associated with the token and used in previous token transactions in its history may be replaced by a new identifier.

Additionally, or alternatively, embodiments may comprise a blockchain-implemented method of issuing at least one token provided in a token transaction on a blockchain. The method may comprise the step of melting and reminting the token when a condition is met. This condition may, for example, comprise determining that pre-determined threshold, limit or specified value has been reached or identified. This provides the advantage that a token's chain of history can be re-started under certain conditions, thus reducing the resources required for processing the lengthy history as mentioned above. Thus, such embodiments provide improved efficiency in terms of storage, processing and time during blockchain-implemented transfers, which retaining security and protection against fraud because the assurance of the token's authenticity is preserved.

In such embodiments, the token transaction is traceable on the blockchain back to at least one mint transaction issued by or on behalf of at least one issuer. Melting the at least one token may comprise providing an identification element, marker or other portion of data to indicate that the token is no longer valid. Additionally, or alternatively, re-minting the token may comprise providing an identification element, marker or other portion of data to indicate that the token is valid. The identifier may provide an indication that the token has been re-minted, and is provided in a modified form relative to one or more previous versions.

The identification element can take any suitable form such as, for example, an identifier and/or cryptographic data. It can be associated with the at least one issuer or a party authorised by the at least one issuer, and can be provided in a blockchain transaction, in the token transaction or in a storage resource provided off the blockchain.

The step of assessing whether the pre-determined threshold, limit or specified value has been reached or encountered may comprise performing a comparison of a supplied or calculated value against the threshold, limit or specified value. The pre-determined threshold, limit or specified value may be determined by the at least one issuer or a party authorised by the at least one issuer, a user or a validating entity.

Methods of the disclosure can be implemented in a system comprising computing equipment. This may comprise
memory comprising one or more memory units; and
processing apparatus comprising one or more processing units, wherein the memory stores code arranged to run on the processing apparatus, the code being configured so as when on the processing apparatus to perform the method of any embodiment disclosed or claimed herein.

The disclosure also provides a computer program embodied on computer-readable storage and configured so as, when run on one or more processors, to perform the method of any embodiment disclosed or claimed herein.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3A is a schematic block diagram of a client application,

FIG. 3B is a schematic mock-up of an example user interface that may be presented by the client application of FIG. 3A,

FIG. 4A schematically illustrates the blockchain ledger as a directed acyclic graph partitioned by two transaction chains,

FIG. 4B schematically illustrates the blockchain ledger as a blockchain where each block contains a new coinbase transaction,

FIG. 5 schematically illustrates an example of an outpoint-signature directed acyclic graph,

FIG. 6 schematically illustrates an example of a token network that connects to the blockchain network, and

FIG. 7 schematically illustrates an example system for implementing embodiments of the present invention.

### DETAILED DESCRIPTION OF EMBODIMENTS

### Example System Overview

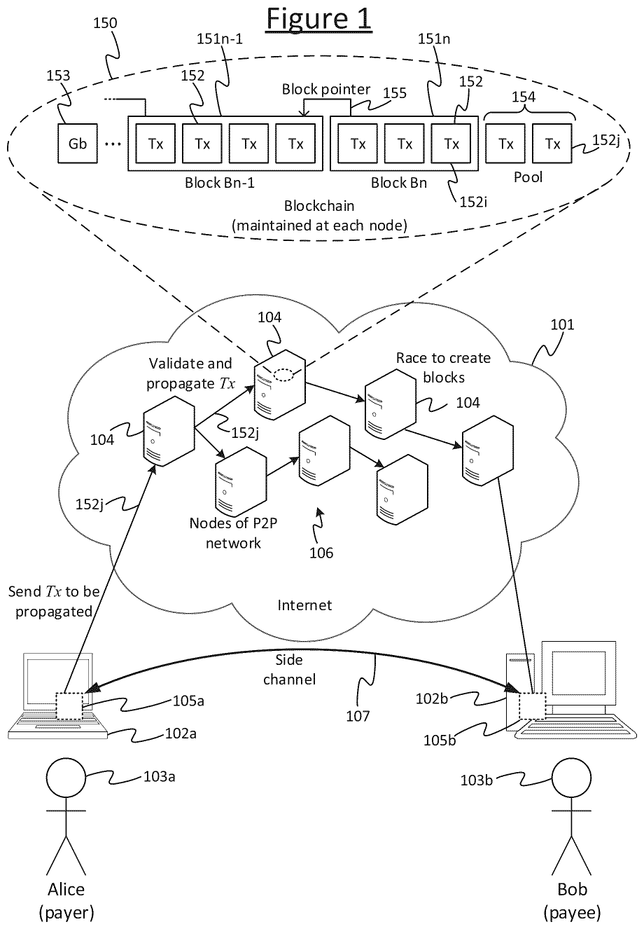

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (e.g. spent) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively, the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### UTXO-Based Model

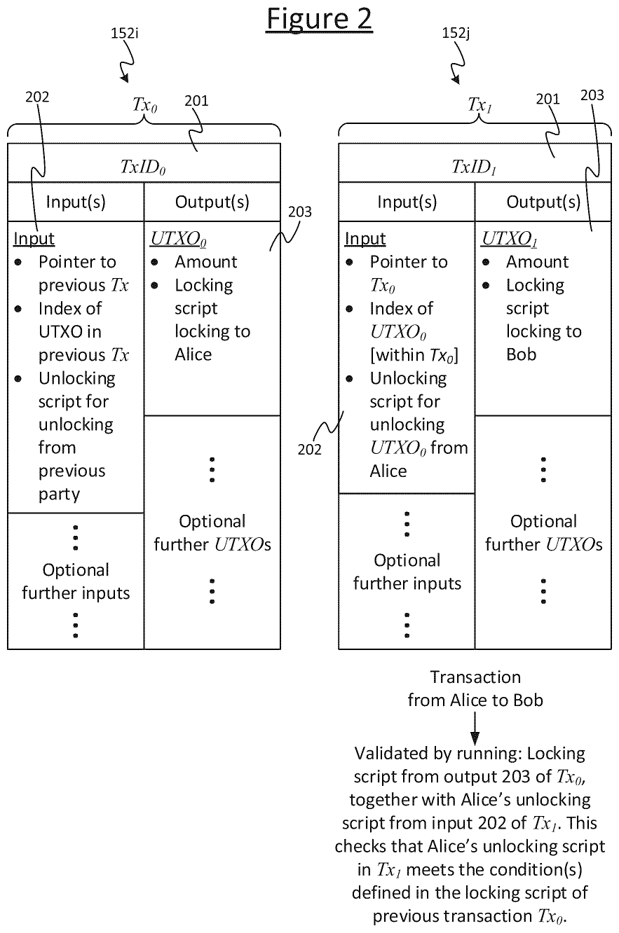

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}><P_{A}>∥[Checksig P_{A}]

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150.

There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an output of a transaction that can store data within the transaction, and thereby record the data immutably in the blockchain 150. E.g. the data could comprise a document which it is desired to store in the blockchain.

Typically, an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### Client Software

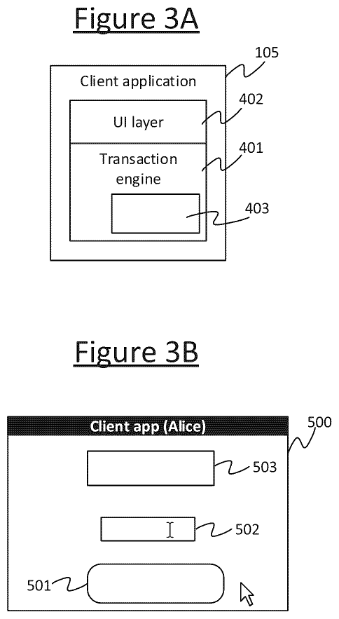

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly. In accordance with embodiments disclosed herein, the transaction engine 401 of each client 105 may comprise a function 403 configured to generate token transactions.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands).

Alternatively or additionally, the UI elements may comprise one or more data entry fields 502. These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

### Blockchain as Directed Acyclic Graph

The Bitcoin ledger is widely referred to as a blockchain where the data structure is considered as a chain of blocks. However, if we take transactions as the basic elements (instead of blocks), we can see the Bitcoin ledger can be considered as a directed acyclic graph. This section provides a formal definition of Bitcoin directed acyclic graph (BDAG) and a special type of subgraphs of BDAG.

### Definition—Bitcoin Directed Acyclic Graph

A Bitcoin directed acyclic graph (BDAG) is a DAG where
1. nodes are Bitcoin transactions, and
2. a directed edge is established from one node to another if at least one output is assigned (spent) from the first node to the second node.

Note that the graph is acyclic because a directed cycle of transactions would imply a circular reference of transaction IDs in their inputs, which is impossible.

Based on the definition, we can highlight a few properties.
1. each node can have at most n outward edges where n is the number of spendable outputs in the transaction represented by this node,
2. a coinbase node has no inward edges, and
3. starting at any node and following the opposite direction of the edges, the path should be ended at one or more coinbase nodes.

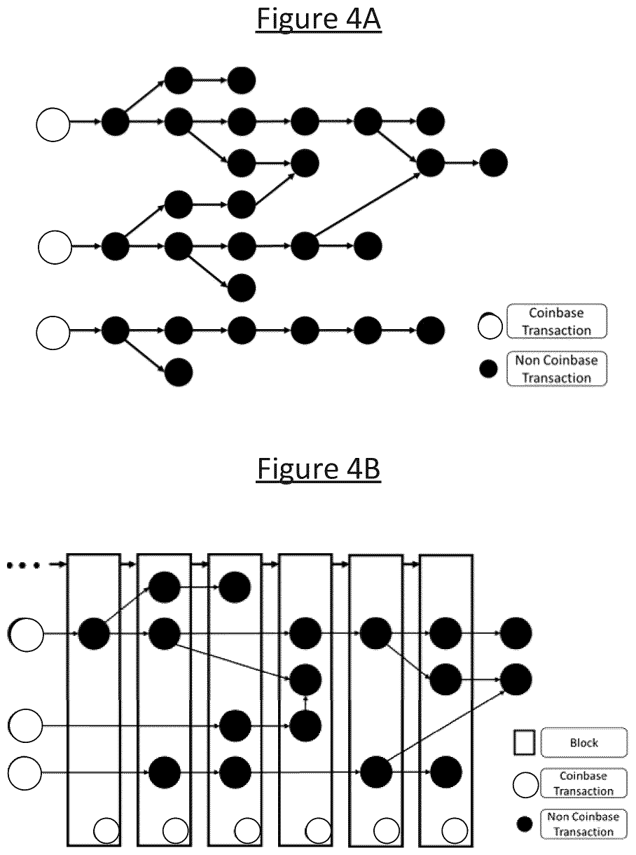

An example of a BDAG is given in FIG. 4A. FIG. 4B shows the BDAG when the blockchain structure is stamped to the BDAG.

### Definition—Transaction Path

A transaction path from node A to node B in a BDAG is a set of nodes N₀, N₁, . . . , Nₜ, where
1. N₀ is node A and Nₜ is node B,
2. there is a directed edge from Nᵢ to Nᵢ₊₁ for all i=0, 1, . . . , t−1, and
3. t is defined to be the length of the path.

### Definition—Transaction Chain

A transaction chain is a subgraph of a BDAG that is connected. That is, for any pair of nodes in the subgraph, there is a path between the two nodes ignoring the directions of the edges. Note that all transaction chains in BDAG form a partition of BDAG.

As in FIG. 4A, we have two transaction chains. The first one starts with two coinbase transactions and it can be considered as a merge of two transaction chains, while the second one starts with one coinbase transaction and has a much simpler structure.

Note that whilst the above example refers to the Bitcoin ledger (i.e. the Bitcoin blockchain), the same definition applies to other UTXO-style blockchains.

### Validating/Certifying Tokens

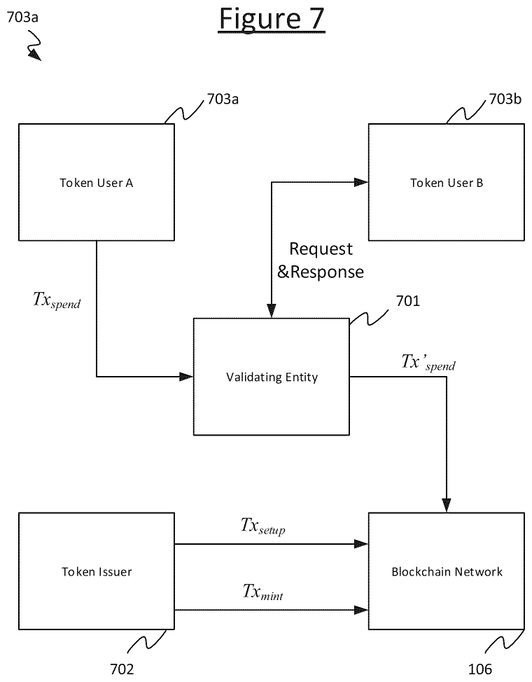

Embodiments of the present invention relate to validating token transactions. FIG. 7 illustrates an example system 700 which some embodiments of the present disclosure may be used with. However, the present invention is not limited to use with just this example system; it provides a more generalised solution for certification of blockchain tokens, and the invention is not limited with regard to the type of tokenisation method or protocol that is used to generate and/or process the token.

As shown in FIG. 7, an illustrative tokenisation system 700 comprises a validating entity 701, a token issuer 702, one or more token users 703a, 703b and the blockchain network 106. Note that whilst only two token users 703a,703b are shown in FIG. 7, in general the system 700 may comprise any number of token users 703. Each of the token issuer 702 and the one or more token users 703 may take the form of Alice 103a or Bob 103b as described with reference to FIGS. 1 to 3. That is, each of the token issuer 702 and the token users 703 may be configured to perform some or all of the operations performed by Alice 103a and/or Bob 103b.

The validating entity 701 may take one of several forms, the details of which will be discussed below. However, in general the validating entity 701 may operate computer equipment comprising a processing apparatus comprising one or more processors, e.g. one or more CPUs, GPUs, other accelerator processors, application specific processors, and/or FPGAs. The computer equipment further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment stores software may comprise a respective instance of at least one client application arranged to run on the processing apparatus. It will be understood that any action attributed herein to the validating entity 701 may be performed using the software run on the processing apparatus of the computer equipment. The computer equipment of the validating entity 701 may comprise at least one user terminal, e.g. a desktop or laptop computer, a tablet, a smartphone, or a wearable device such as a smartwatch. The computer equipment of the validating entity 701 may also comprise one or more other networked resources, such as cloud computing resources accessed via the user terminal. The client application may be initially provided to the computer equipment of the validating entity 701 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The validating entity 701 is configured to validate token transaction. The validating entity 701 has access to a mint transaction. A mint transaction mints, i.e. issues, an amount of tokens. The mint transaction may be signed by the token issuer 702 (i.e. the mint transaction may include an input comprising a signature linked to an issuing public key owned by the token issuer 702) and comprises an output that locks an initial amount of tokens. In other examples, the mint transaction may include a different form of cryptographic data, e.g. a minting public key, a message signed by the token issuer, a message encrypted by the token issuer, etc. In general, the mint transaction includes cryptographic “minting” data. Cryptographic data is data that is used as part of a cryptographic scheme. The minting data is public information known to be associated with the minting of tokens. The mint transaction may include more than one output that locks a respective initial amount of tokens. The mint transaction is recorded on the blockchain 150. The validating entity 701 may access the mint transaction from the blockchain 150, or the validating entity 701 may store the mint transaction locally. In some examples the minting data may be a knowledge proof, e.g. a hash puzzle or r-puzzle. The knowledge proof requires knowledge of data in order to be solved, i.e. unlocked.

The validating entity 701 obtains a “target token transaction”, i.e. a token transaction that is to be validated by the validating entity 701. The target token transaction may be submitted to the validating entity 701 by a token user 703. Or, the target token transaction may be submitted to the validating entity by a different validating entity 701. That is, the system 700 may comprise multiple validating entities, e.g. the token server 601 and the token client of FIG. 6. The target transaction may be obtained in some other way.

In order for the target token transaction to be a valid token transaction it must be part of a transaction chain that leads back to the mint transaction. That is, the target transaction must include an input that either references (i.e. spends) an output of the mint transaction, or that references a previous token transaction that is part of the transaction chain leading back to the mint transaction. In the latter case, the previous transaction must include an input that either references an output of the mint transaction, or that references a previous token transaction that is part of the transaction chain leading back to the mint transaction. In other words, tracing the referenced outputs of the previous token transactions must eventually lead to the token transaction.

The validating entity 701 may be configured to verify the token(s) of the target transaction by performing said tracing of the referenced outputs. Or, the validating entity 701 may perform a more efficient process to verify the first condition, as discussed below.

Once validated, i.e. once the authenticity of the token(s) in the target token transaction has been established, the validating entity 701 may submit the target token transaction to the blockchain network 106. That is, a token user 703a may submit the target token transaction to the validating entity for network validation in accordance with the blockchain protocol, and on condition that the target token transaction is validly formed, the validating entity 701 forwards the target token transaction to the blockchain network 106 for inclusion on the ledger.

The validating entity 701 may obtain confirmation that the target token transaction is a valid blockchain transaction. For instance, the validating entity 701 may obtain confirmation that the target token transaction has been published in a block 151 on the blockchain 150. The validating entity 701 may obtain a Merkle proof from a blockchain node 104 for verifying that the target token transaction has been published in the block 151. Once satisfied that the target token transaction is a valid blockchain transaction, the validating entity 701 may record the target token transaction in a list of valid token transactions. Note that the validating entity 701 may record the target token transaction in the list of valid token transactions before obtaining confirmation that the target token transaction is a valid blockchain transaction. The validating entity 701 may choose to delete the target token transaction from the list in the event that the target token transaction is not a valid blockchain transaction.

In some examples, having validated the target token transaction, the validating entity 701 may sign the target token transaction before submitting it to the blockchain network 106. For instance, the target token transaction may be incomplete, and the validating entity 701 may complete the target token transaction by including an input comprising the validating entity's signature, i.e. a signature linked to a public key owned by the validating entity 701. This signature signifies that the target token transaction has been validated. In some examples, the input may be a fee payment input, i.e. an input that pays the transaction fee collected by the blockchain node 104 that publishes the transaction in a block 151. Such an input is an example of a “non-token input”.

The target token transaction may comprise one or more non-token outputs. For instance, the non-token output may be used to return the difference between the fee payment input and the transaction fee to the entity that pays the transaction fee. Non-token outputs may serve other purposes. If the target token transaction does comprise one or more non-token outputs, the target token transaction must satisfy a third condition in order to be deemed as a valid token transaction. The validating entity 701 is configured to verify that the total amount of tokens locked by the token output(s) of the target token transaction is not greater than the total amount of tokens locked by the outputs that are referenced by the token inputs of the target token transaction.

In some examples, the validating entity 701 may also validate the mint transaction. For instance, the validating entity 701 may verify that the mint transaction comprises a signature linked to a minting public key associated with the token issuer 702.

The validating entity 701 may receive a request from a requesting entity (e.g. a token user 703b) to confirm whether a token transaction (e.g. the target token transaction) is a valid token transaction. The validating entity 701 may verify that the token transaction is a valid token transaction and, if the token transaction is valid, submit a response to the requesting entity informing the requesting entity is a valid token transaction. This request and response process will be discussed more below.

### Token Server

In some embodiments, the validating entity 701 may comprise a “token server” 601. That is, the validating entity 701 may take the form of (or include) a server configured to perform the actions of the validating entity 701. The token server 601 may store a record (e.g. a database) of valid token transactions, i.e. token transactions that have been previously validated. These token transactions may have been validated by the token server 601, or by a different entity. In some examples, the token server 601 may store a record of all valid transactions.

In these embodiments, the token server 601 may verify that a token input of the target token transaction references an output of a previously validated token transaction by determining whether the referenced transaction is present in the record of valid token transactions, e.g. by performing a look-up of the transaction ID of the referenced transaction.

In some examples, the token server 601 may construct “token blocks”. Token blocks share some similarities with blockchain blocks 151. The token blocks comprise a token block header and a list of valid token transactions (or at least respective identifiers of valid token transactions). The target token transaction, once validated, may be included in a current (i.e. latest) token block. The token block header of a given token block comprises a Merkle root calculated based on the set of token transactions in that token block. The block header may comprise additional fields, as discussed below.

Similarly to blockchain blocks 151, the block header of a token block may comprise a pointer to a previous token block in the sequence (i.e. chain) of token blocks. The pointer may take the form of a hash (e.g. double hash) of the block header of the previous token block. The pointers trace back to the first (i.e. first to be created) token block.

The token server 601 may construct one token block per blockchain block 151. That is, a token block may be constructed based on the transactions (and specifically the token transactions) within a given token block. The token block may be constructed prior to a corresponding blockchain block 151 being published (e.g. if the token transactions that will be included in the blockchain block 151 have been sent to the network 106 by the token server 601), or after the blockchain block 151 has been published (e.g. the token server 601 may scan the blockchain block 151 for token transactions).

Optionally, some or all of the token blocks may comprise one or more signatures. The signatures may be included in the respective block header of a token block. For instance, the token server 601 may include a signature to acknowledge that the token block was indeed constructed by the token server 601. The signed message may comprise some or all of the token block. In some examples, the token issuer 703 and/or one or more additional entities (e.g. an auditor, a government body or other official entity) may include respective signatures.

As well as keeping a record of the token blocks, the token server 601 may transmit (e.g. periodically or upon request) one or more token blocks to a requesting entity, e.g. a token user 703b or token issuer 702. The requesting entity may be the token issuer 702, a token user 703 or a different validating entity (e.g. the token light client described below). The token server 601 may transmit the full token block, or just the token block header.

In some cases, the token server 601 may transmit the token block header (and optionally the full token block) as part of a simplified token verification method to verify the existence and integrity of a valid token transaction. Verifying the integrity of a transaction ensures that the data in the transaction has not been tampered with. For instance, a requesting entity (e.g. token user 702b) may wish to verify that a token transaction is valid. The token transaction under question may be a token transaction that is referenced by an input of a current token transaction, e.g. the target token transaction. To confirm that the referenced token transaction is valid, the token server 601 may provide the requesting entity with a Merkle proof for verifying the existence of the referenced token transaction in a token block. Merkle proofs are known to the skilled person. The Merkle proof transmitted to the requesting entity contains a sequence of hashes. The referenced token transaction is hashed, then concatenated with a first hash in the sequence, the result of which is then hashed. That next result is then concatenated with a next one of the hashes in the sequence (if present), the result of which is then hashed. Each hash in the sequence has a left or right indicator. The leftness or rightness can be determined by a single index which can be provided as the first number in the Merkle proof. This process is repeated until each hash in the sequence has been used. If the final hash is equal to the Merkle root included in the token block header of a token block, then the referenced token transaction is included in the token block. Since only valid token transactions are included in the token block, the referenced token transaction must be valid and the data in the referenced transaction must have not been modified.

### Token Light Client

In some embodiments, the validating entity 701 may comprise a “token light client” 602a. That is, the validating entity 701 may take the form of (or include) a client application configured to perform the actions of the validating entity 701. The token server 601 may store a record (e.g. a database) of valid token transactions, i.e. token transactions that have been previously validated. These token transactions may have been validated by the token light client 602a, or by a different entity.

The token light client 602a maintains a record of token block headers, along with a record of transaction identifiers of valid token transactions. The token light client 602a also stores a record of the token value and index of each token output of the valid token transactions. For instance, the record may comprise a plurality of data items of the form TxID∥index∥value. The token block headers may be obtained from the token server 601, e.g. upon request and/or upon each token block being constructed by the token server 601. In some examples, the token block headers may be of token blocks constructed by the token light client 602a.

The token light client 602a may validate received token transactions using the record. For instance, the token light client 602a may verify that a token output referenced by a token input of the target transaction is stored in the record. E.g. the token light client 602a performs a look up of the referenced TxID∥index∥value in the record. If the target token transaction is valid (i.e. satisfies the one or more conditions for validity), the token light client 602a may add the token output(s) of the target transaction in the record. In some examples, the token light client 602a may remove the referenced token outputs from the record.

The token light client 602a may receive token transactions from token users 703, validate the token transactions, and then submit them to the blockchain network 106 and/or to the token server 601.

Like the token server 601, the token light client 602a may also construct token blocks. These token blocks may take the same form as those constructed by the token server 601. For instance, the token light client 602a may receive token transactions from token users 703 and construct a token block based on those token transactions. The token light client 602a may also include in a token block token transactions which have been sent to different instance of the token light client 602a, and which are then forwarded to the token light client 602a or obtained from the blockchain 150 (after being submitted to the blockchain network 106 by the other token light client). Like the token server 601, the token light client 602a may construct a token block for each newly published block of the blockchain 150.

In some examples, the token light client 602a may send the token blocks which it constructs to the token server 601, e.g. to be verified by the token server 601. The token server 601 may add its signature to the token block header of such token blocks, and return them to the token light client 602a. In some examples, the token light client 602a may receive token blocks from the token server 601. For instance, the token light client 602a may temporarily lose its connection to the blockchain network 106 and therefore be unable to construct token blocks during that time.

Like the token server 601, in some cases the token light client 602a may transmit a token block header (and optionally the full token block) as part of a simplified token verification method to verify the existence of a valid token transaction. A similar scenario applies, where the token light client 602a sends to a requesting entity (e.g. token user 703) a block header and a Merkle proof for a valid token transaction included in the corresponding token block. If the Merkle proof leads to the Merkle root included in the block header, the token transaction can be confirmed as being included in the token block, and as such, is a valid token transaction.

### Token UTXO Client

As shown in FIG. 6, the system may comprise one or more token UTXO clients 602b. These client applications are also configured to validate token transactions. That is, the validating entity 701 may take the form of a token UTXO client application 602b. The token UTXO client keeps a record of one token snapshots. A token snapshot comprises a set of token UTXOs. Each token UTXO is an unspent token output of a token transaction. Each token snapshot captures the set of token UTXOs at a different point in time.

Some or all of the token snapshots are constructed by the token UTXO client 602b. Some may be received from a different instance of the token UTXO client 602b or received from the token server 601. In some instances, the token server 601 may construct a token snapshot and send it to the token UTXO client 602b, e.g. in response to the token UTXO client 602b losing a connection to the blockchain network 106. A token snapshot may be constructed by tracking the token UTXOs on the blockchain, i.e. tracking which token outputs are yet to be validly spent by a later blockchain transaction (token or non-token).

The token UTXO client 602b is configured to validate token transactions, e.g. the target token transaction, by verifying that each token input of the target token transaction references a respective unspent token output of a previous token transaction (which may be the mint transaction). The token UTXO client 602b does this by verifying that the referenced token output is present in the latest token snapshot.

Upon validating the token transaction, the token UTXO client 602b may transmit the token transaction to the blockchain network 106 and/or to the token server 601. The token UTXO client 602b may construct a new token snapshot which includes the token output(s) of the target transaction but does not include the referenced token outputs.

The token UTXO client 602b may also perform a simplified token verification method to verify the existence of a valid token output. Each token UTXO snapshot may comprise a

Merkle root calculated based on the token UTXOs stored in the snapshot. To verify the existence of a token output, the token UTXO client 602b may transmit to a requesting entity (e.g. a token user 703) a Merkle path linking a given token UTXO to the Merkle root of the current token snapshot. Note that the Merkle root may be constructed for a Merkle tree whose leaves take one of the following forms:
1. TxID∥index
2. TxID∥index∥value
3. TxID∥index∥locking script∥value

### Example Token System

An example token system will now be described. It will be appreciated that some features of the token framework are optional and other variations may be selected based on the particular implementation of embodiments of the invention. According to one example framework, there is a dust limit imposed on blockchain transactions, the value of the token is pegged to the native blockchain token, and there is no token-specific data is pushed to locking scripts.

### Setup Transaction

The token issuer 702 may publish a setup transaction. Suppose the token issuer 702 would like to issue tokens that represent a national currency. Note that this is just one of many possible use cases of the token system. The token issuer 702 can choose to publish the specification of her tokens on-chain in an unspendable (e.g. OP_FALSE OP_RETURN) payload in a setup transaction. Alternatively, the specification may be published on a website or any other appropriate public record as long as the record is trusted by the users and the public in general. This will allow the token issuer 702 to open the token chain to the public and allow them to attest the rules of her tokens. Whenever there is a dispute, the token users 703, including the token issuer 702, can refer to the specification to settle the dispute. One can think of the specification as the article of a public company or the terms and conditions for the token system. The specification can reference ERC-20 standards, Tokenised standards, or any customised standards which the token issuer feel appropriate. If the token chain is private, then the specification can be published in its hash value to ensure its integrity.

An example of a setup transaction is given below:

TxIDₛₑₜᵤₚ

| | | | |
|---|---|---|---|
| Version | 1 | Locktime | 0 |
| In-count | 1 | Out-count | 2 |

| Input list | | Output list | |
|---|---|---|---|
| Outpoint | Unlocking script | Value | Locking script |
| Alice's | <Sigᵢₛₛᵤₑ> | x₀ | OP_DUP OP_HASH160 <H(PK₀)> OP_EQUALVERIFY |
| outpoint 0 | <PKᵢₛₛᵤₑ> | satoshi | OP_CHECKSIG |
| | | 0 | OP_FALSE OP_RETURN <Specification> |

| | |
|---|---|
| Token | Great Blockland Pound (GBP) |
| Public key for minting | PKₘᵢₙₜ |
| Public key for melting | PKₘₑₗₜ |
| Pegging ratio (token:satoshi) | 1:1000 |
| Reserve:Issuance | 1:1 |
| Contact detail | Alice@ctsforgbp.com |
| Jurisdiction | Great Blockland |
| Issuance Licence | Central Bank of Great Blockland |
| Third Party Audit | Auditing Company (PK_{Audit}) |
| Auditing Dates | 1^{st} Thursday in every month |
| Token Validation | GBP Token Guide.pdf |
| Extra Information | GBP for everyone |

where <Specification> can be

The token issuer 702 signs the setup transaction with a signature and includes an issue public key. The setup transaction may reference any unspent transaction output (UTXO) owned by the token issuer 702. Similarly, the output of the setup transaction may be locked to any arbitrary public key, e.g. a different public key owned by the token issuer 702.

Note that the specification given above is for illustration purpose only. The token issuer 702 can include all the details about the token system in this setup transaction. Generally, the specification is intended to demonstrate that the token system is technically robust and legally compliant.

Three public keys are explicitly shown in the example specification. PKₘᵢₙₜ is used to mint tokens, PKₘₑₗₜ is used to melt coins, and PK_{Audit} is used to attest the compliance of the token system. All three public keys are certified by the signature from the token issuer 702 in the input of the setup transaction. Other types of minting data may be included in the specification instead of or as well as the public keys.

The token issuer 702 can add more public keys to provide more sophisticated access control structure. For example, there may be public keys for transaction validators 701, in which case a token transaction may be validated and signed by validators 701 before being sent to the blockchain network 106. The token issuer 702 can also add a master certificate public key to create a hierarchical structure of certified public keys as the token system evolves. There may also be public keys dedicated to paying transaction fees, as discussed below.

In the example framework the tokens are pegged to the native blockchain token. For brevity, the example of bitcoin will be used herein but it should be appreciated that this not limiting on all embodiments. In that case, there is a fixed conversion rate between bitcoin and the tokens. Note that this is not an exchange rate. This is simply a convenient representation of the token value. For example, 1000 satoshis (sats) may represent 1 GBP. Given a token transaction that has 10,000 sats as its output, the token output therefore has a token value of 10 GBP. It is worth noting that because of the dust limit, which is at 546 satoshi at the time of writing, it may be more convenient to define the pegging ratio to be 1:dust limit, where 1 is the smallest non-divisible unit of the token.

Note that in this example the specification may include the reserve-issuance ratio. This is to suggest that the token issuer 702 cannot issue more tokens than its financial capability. The token issuer 702 may also need to have a valid licence from the central bank to be allowed to issue GBP tokens. The jurisdiction field can specify where the token system is regulated, and relevant laws can be applied. These compliances may be audited by a third party, and the auditing results may be put on chain for transparency. In general, all traditional approaches to a financial entity or a token issuer can be integrated into the example token framework. Any enforcement of rules, regulations, or laws can be a combination of on-chain and off-chain natures.

### Mint Transaction

To mint tokens, the token issuer 702 constructs a mint transaction. An example is given below:

TxIDₘᵢₙₜ

| | | | |
|---|---|---|---|
| Version | 1 | Locktime | 0 |
| In-count | 1 | Out-count | 1 |

| Input list | | Output list | |
|---|---|---|---|
| Outpoint | Unlocking script | Value | Locking script |
| mint | <Sigₘᵢₙₜ> | 1000x₁ | OP_DUP OP_HASH160 <H(PK₁)> OP_EQUALVERIFY |
| outpoint | <PKₘᵢₙₜ> | satoshi | OP_CHECKSIG |

This example transaction has one input that is prepared by the token issuer 702 and contains a signature that can be verified by the public key PKₘᵢₙₜ. The mint transaction may include a different form of cryptographic data, e.g. a signed or encrypted message. According to the specification in TxIDₛₑₜᵤₚ, this transaction mints x₁ GBP tokens, and they are assigned to the owner of PK₁.

The transaction fee is value of mint outpoint—1000x₁, and here it is assumed that the mint outpoint was prepared by the token issuer 702 to have the exact amount to cover both the transaction fee and the value of the first output. More discussion on the transaction fee can be found below.

A blockchain transaction is defined to be a token mint transaction if
1. all inputs in the transaction contain a signature or signatures that can be verified by the minting public key or minting public keys, and
2. it is a valid blockchain transaction.

The implication of the definition is that the bitcoin are coloured with the minting public keys. The colour is then preserved through the entire transaction chain that starts with the mint transaction or multiple mint transactions. To check whether a blockchain transaction is a token transaction, one can trace back to a mint transaction via the transaction chain. However, this can give rise to technical challenges and so embodiments of the disclosure are provided to alleviate or eliminate these problems, as discussed below.

The token issuer 702 will be able to construct more than one such transaction to meet the demand of the tokens. In this case, the number of tokens that can be minted is limited by the number of bitcoin the token issuer 702 has and the rules in the specification.

### Spend Transaction

Once the mint transaction is published on the blockchain 150, the token user 703 who owns the public key to which the token output of the mint transaction is locked, can spend the tokens.

Consider the following transaction, TxID_{spend}, which spends TxIDₘᵢₙₜ.

TxID_{spend}

| | | | |
|---|---|---|---|
| Version | 1 | Locktime | 0 |
| In-count | 1 | Out-count | 1 |

| Input list | | Output list | |
|---|---|---|---|
| Outpoint | Unlocking script | Value | Locking script |
| TxIDₘᵢₙₜ \|\| 0 | <Sig₁><PK₁> | 1000x₂ | OP_DUP OP_HASH160 <H(PK₂)> |
| | | satoshi | OP_EQUALVERIFY OP_CHECKSIG |

This transaction has no explicit reference to the public key PKₘᵢₙₜ. To identify this transaction as a token transaction, we need to trace back to the transaction that is referenced in the input, which is TxIDₘᵢₙₜ. By obtaining TxIDₘᵢₙₜ either locally or from the blockchain network 106, we can verify that it is a valid token mint transaction, and therefore TxIDₛₚₑₙₜ is a token transaction. To validate the token transaction, three main checks are required:
1. the outpoint referenced in the input is unspent;
2. the output value is not greater than the input value; and
3. the signature is valid (or script validation is successful).

Note that all these checks coincide with the normal blockchain transaction validation. Therefore, all checks can be delegated to blockchain nodes 104. To summarise, traditionally a validation on token transactions consists of only two steps:
1. check the input can be traced back to a token mint transaction, and
2. obtain a confirmation from blockchain nodes that the token is blockchain valid.

Embodiments of the disclosure, however, provide modifications as discussed below.

### Transaction Fees

There are three ways in which the transaction fees may be handled. The first is a token-only approach. In order to keep the simplicity in token transaction validation, and to ensure that token transactions consist of only token inputs and outputs, we can pay the transaction fee by burning a small fraction of the tokens. As shown in TxID_{spend}, the owner of PK₁ transfers x₂ GBP token to the owner of PK₂. The transaction fee 1000(x₁−x₂) effectively burns (x₁−x₂) tokens. For token users, this can be considered as the fee for token transfers. For token issuers, this means that the number of tokens in the system diminishes over usage. This might be a desired feature for some type of tokens that naturally depreciate. On the other hand, if this is an issue for the token issuer 702, it can mint new tokens from time to time to compensate the transaction fees.

If zero-fee transactions are acceptable to blockchain nodes 104, then the issue of paying fees for token transactions will be eliminated. However, the token issuer 702 may have to pay blockchain nodes 104 off-chain in fiat via a business contract. In this case, the token issuer 702 effectively is paying transaction fees for the token users 703.

The second is a public-key approach. Another possibility is to use public keys to indicate the purpose of an input in a token transaction. In this case, the token issuer 702 can introduce a fee-payment public key or a set of them in the specification in the setup transaction. The fee-payment public keys can be owned by token issuers and distributed to token wallets. The idea is to add one more input to every token spending transaction to cover the transaction fees in exact amount. An example is given below.

TxID_{spend}′

| | | | |
|---|---|---|---|
| Version | 1 | Locktime | 0 |
| In-count | 2 | Out-count | 1 |

| Input list | | Output list | |
|---|---|---|---|
| Outpoint | Unlocking script | Value | Locking script |
| TxIDₘᵢₙₜ \|\| 0 | <Sig₁><PK₁> | 1000x₁ | OP_DUP OP_HASH160 <H(PK₂)> |
| | | satoshi | OP_EQUALVERIFY OP_CHECKSIG |
| Fee outpoint | <Sig_{fee}><PK_{fee}> | | |

Note that the fee outpoint is not a token input in the sense that we cannot trace it back to a token mint transaction. However, as the public key in the unlocking script can be identified as a valid public key certified by the token issuer 702, the fee outpoint does not invalidate the token transaction. To make it more flexible, the token issuer may allow users to register their fee-payment public keys. A list of certified fee-payment public keys can be published in an updated version of the specification.

The advantage of this approach is that all outputs of token transactions are token outputs. This provides the simplicity during validations. As a token issuer 702, it is also possible to use the fee-payment input as an approval for the token transfer. A token user 703 constructs a partial transaction first. The token issuer 702 or the wallet software approves the transaction by adding a fee input to complete the transaction. This additional approval process will also prevent users from accidentally burning tokens.

There are two disadvantages of this approach with respect to the token-only approach.
1. A couple of additional checks must be introduced.
   a. Check that the fee-payment public key is included in the specification.
   b. Check that the value of the output is equal to (or not greater than) the value of the token input. This is to make sure that token users do not inflate the token output value by “borrowing” some bitcoins from the fee-payment input. In the token-only approach, the input consists of token inputs only, so the check is the same as whether the total output value is not greater than the total input value, and this can be delegated to blockchain nodes 104.
2. The fee outpoint must contain the exact amount for paying the transaction fee. No changes can be collected as we do not allow non-token outputs. This requires token users or token issuers to prepare the fee outpoints before they can transfer a token.

The overhead created by 1b is negligible in terms of computation, and the benefit it brings is quite significant in terms of preventing accidental burning of tokens. The second disadvantage can also be mitigated by having a fee outpoint pool or server owned by the token issuer 702 to provide appropriate fee outpoint for each token transaction request.

The third is a SIGHASH_SINGLE approach. The goal here is to address the lack of flexibility in paying transaction fees and disentangle token and non-token outputs at the same time. We observe that to pay the transaction fee and to collect some changes require only one input and one output from a token transaction. We can use SIGHASH_SINGLE to link this pair of input and output so that the output can be distinguished from other outputs.

SIGHASH_SINGLE is a flag attached to a signature to indicate that the message signed by the signature excludes all outputs except for the output that has the same index as the input that contains the signature. Note that other blockchains may use a different signature flag for the same purpose and SIGHASH_SINGLE is used only as an illustrative example. This implies that one can add or modify outputs to the transaction without invalidate the signature if the index of the signed output stays the same. As we have not included SIGHASH_NONE, no input can be added or modified.

To construct a spending transaction, the user submits a token input to their wallet software or an entity that funds the transaction fee (can be user themselves), e.g., TxIDₘᵢₙₜ∥0. An incomplete transaction is then constructed as:

TxID_{spend-incomplete}″

| | | |
|---|---|---|
| Version | 1 Locktime | 0 |
| In-count | 2 Out-count | 1 |

| Input list | | Output list | |
|---|---|---|---|
| Outpoint | Unlocking script | Value | Locking script |
| Fee outpoint | <Sig_{fee}\|\|SINGLE> | z | OP_DUP OP_HASH160 <H(PK_{fee})> |
| | <PK_{fee}> | satoshi | OP_EQUALVERIFY OP_CHECKSIG |
| TxIDₘᵢₙₜ \|\| 0 | | | |

Note that the signature Sig_{fee} signs all the inputs and the first output shown in TxID″_{spend-incomplete}.

Upon receiving or constructing the incomplete transaction, the user 703 completes it by adding any number of token outputs and signs the updated transaction.

TxID_{spend}″

| | | | |
|---|---|---|---|
| Version | 1 | Locktime | 0 |
| In-count | 2 | Out-count | 3 |

| Input list | | Output list | |
|---|---|---|---|
| Outpoint | Unlocking script | Value | Locking script |
| Fee outpoint | <Sig_{fee}\|\|SINGLE> | z | OP_DUP OP_HASH160 <H(PK_{fee})> |
| | <PK_{fee}> | satoshi | OP_EQUALVERIFY OP_CHECKSIG |
| TxIDₘᵢₙₜ \|\| 0 | <Sig₁><PK₁> | 1000x₂ | OP_DUP OP_HASH160 <H(PK₂)> |
| | | satoshi | OP_EQUALVERIFY OP_CHECKSIG |
| | | 1000x₃ | OP_DUP OP_HASH160 <H(PK₃)> |
| | | satoshi | OP_EQUALVERIFY OP_CHECKSIG |

In this transaction, the signature Sig₁ signs all inputs and outputs. We have the following equations on values:

$$\begin{matrix}transaction fee = value of fee outpoint - z \\ {x}_{1} = {x}_{2} + {x}_{3}\end{matrix}$$

There are a few methods to distinguish a fee-payment input from a token input.
1. Check whether the input is a token output. This would be quite difficult if there is no list of token outpoints for reference. If one starts to trace back from the fee outpoint, it might take long time to reach a negative conclusion.
2. Define the first input always to be the fee-payment input. This can be implemented as part of the wallet software.
3. Define the input with SIGHASH_SINGLE to be the fee-payment input. This implies that no other token input can use SIGHASH_SINGLE.

Assuming that we can distinguish a fee-payment input from a token input, to identify the non-token output is simply to check whether the index of the output is the same as the index of the fee-payment input.

However, if we assume that SIGHASH_SINGLE is used to flag the fee-payment input (method 3), then we can identify the non-token output directly without identifying the fee-payment input. For each output, we can count the number of signatures that have signed that output. The non-token output has the greatest number of signatures because it always has at least one extra from the fee-payment input.

This feature of the token outputs induces another type of directed acyclic graph at outpoint level.

Outpoint-Signature Directed Acyclic Graph (O-S DAG)

An outpoint-signature directed acyclic graph is a DAG where
1. nodes are blockchain transaction outpoints, and
2. a directed edge is established from one node to another if the second node is part of the message that is signed by a signature that is required to assign (spend) the first node.

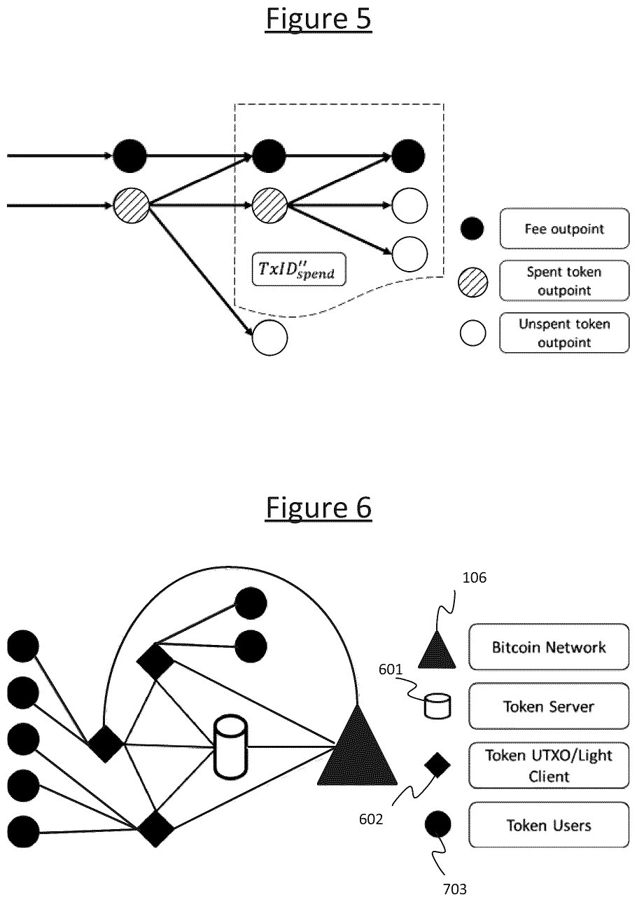

Roughly speaking, we have the outpoints as nodes and the signatures as edges. All edges in an O-S DAG are established within the blockchain transactions. FIG. 5 illustrates an example of an O-S DAG with TxID″_{spend} as an example.

The advantage of this SIGHASH_SINGLE approach is to provide the flexibility in paying the transaction fee.

### Security on Non-Token Inputs

We have introduced non-token inputs to token transactions to pay transaction fees. These non-token inputs may be used either accidentally or maliciously to inflate the value of the token outputs. A check needs to be implemented to make sure that those token transactions are deemed to be invalid.

Assuming that the total input value in satoshi of a token transaction is VIₜₒₖₑₙ+VIₙₒₙ₋ₜₒₖₑₙ, the total output value is VOₜₒₖₑₙ+VOₙₒₙ₋ₜₒₖₑₙ, and the transaction fee is V_{fee}, then we have

$${VO}_{token} + {VO}_{non - token} + {V}_{fee} = {VI}_{token} + {VI}_{non - token} .$$

We expect that VOₜₒₖₑₙ=VIₜₒₖₑₙ. However, a token user can take some satoshis from either VOₙₒₙ₋ₜₒₖₑₙ or V_{fee}. That is,

$${VO}_{token}^{′} + {VO}_{non - token}^{′} + {V}_{fee}^{′} = {VO}_{token} + {VO}_{non - token} + {V}_{fee}$$

$$where$$

$${VO}_{token}^{′} > {VO}_{token}^{} and {VO}_{non - token}^{′} + {V}_{fee}^{′} < {VO}_{non - token} + {V}_{fee} .$$

As a blockchain transaction, it is still valid. As a token transaction, this is considered invalid. An example of a pair of token transactions are given below.

TxID_{token-valid}

| | | | |
|---|---|---|---|
| Version | 1 | Locktime | 0 |
| In-count | 2 | Out-count | 2 |

| Input list | | Output list | |
|---|---|---|---|
| Outpoint | Unlocking script | Value | Locking script |
| Fee outpoint | <Sig_{fee}\|\|SINGLE> | 3000 | OP_DUP_OP_HASH160 <H(PK_{fee})> |
| (5000 satoshi) | <PK_{fee}> | satoshi | OP_EQUALVERIFY OP_CHECKSIG |
| Token outpoint | <Sig₁><PK₁> | 1000 | OP_DUP_OP_HASH160 <H(PK₂)> |
| (1000 satoshi) | | satoshi | OP_EQUALVERIFY OP_CHECKSIG |

TxlD_{token-invalid}

| | | | |
|---|---|---|---|
| Version | 1 | Locktime | 0 |
| In-count | 2 | Out-count | 3 |

| Input list | | Output list | |
|---|---|---|---|
| Outpoint | Unlocking script | Value | Locking script |
| Fee outpoint | <Sig_{fee}\|\|SINGLE> | 3000 | OP_DUP_OP_HASH160 <H(PK_{fee})> |
| (5000 satoshi) | <PK_{fee}> | satoshi | OP_EQUALVERIFY OP_CHECKSIG |
| Token outpoint | <Sig₁><PK₁> | 2000 | OP_DUP OP_HASH160 <H(PK₂)> |
| (1000 satoshi) | | satoshi | OP_EQUALVERIFY OP_CHECKSIG |

The first transaction is token-valid in the sense that the token output has the same value as the token input, and the difference between the fee input and fee output indicates a transaction fee of 2000 satoshi. The second transaction is token-invalid in the sense that the token output is greater than the token input. However, the difference between the total value of the inputs and the total value of the outputs indicates a transaction fee of 1000 satoshi. This transaction is blockchain-valid and would be accepted by the blockchain nodes. Therefore, if this transaction was published, then the token value that is represented by 1000 satoshi would be lost.

In token-only approach and public-key approach, the fee-payment input must be added after the token input and output are finalised. Therefore, the fee-payment entity (token issuer or wallet software) can enforce a check before signing the token transaction. It is worth noting that there is no incentive for users to deliberately inflate token outputs in this way, as it will burn their tokens. On the other hand, any accidental mistakes will be recorded immutably on the blockchain. Token users may show the token issuer that the accident was genuine, and the issuer may choose to mint new tokens to reimburse the user. However, it is still important to avoid any accidental mistakes.

### Token Transaction Validity

We have covered how tokens can be minted and spent. We can now give a comprehensive definition on the validity of a token transaction.

### Definition—Token Outpoint

An outpoint TxID∥Index is a token outpoint if
1. the transaction TxID is a token mint transaction, or
2. there is a transaction path from a token mint transaction to the transaction TxID and
3. the index does not correspond to the index of a fee-payment input or a non-token input.

### Definition—Token Transaction Validity

A token transaction is valid if it is a valid token mint transaction or
1. it is blockchain valid,
2. at least one of its inputs references a token outpoint, and
3. the total value of its token outputs is less than or equal to the total value of its token inputs.

Given the definitions above, for each blockchain transaction, one needs to trace it back to a mint transaction or a coinbase transaction. If they end up with a mint transaction, then the transaction is a token transaction. If they end up with a coinbase transaction without identifying a mint transaction, then the transaction is not a token transaction. It may be difficult to identify a token transaction and validate it when the token system scales. One way to improve this is to keep a record of known valid token transactions. Instead of tracing all the way back to a mint transaction, a validator can stop at a known valid token transaction. Moreover, if the validator has access to a trusted set of unspent token outpoints, then the tracing can be replaced by a look-up operation that checks the membership of the set.

To address the scalability of our token systems, we propose a few options to optimise token transaction validations. We start with a description of a token server 601 that keeps a record of all the token transactions. We then propose a block structure on the record which leads us to a description of a light client for the token system. To improve the efficiency further, a token client can be utilised that makes use of token UTXO snapshots.

### Definition-Token Server

A token server 601 must satisfy the following requirements:
1. being able to validate token transactions; and
2. having a connection to the blockchain network.

The first requirement implies that a token server 601 must store some information about the token system to recognise that the inputs of a blockchain transaction are token inputs. There are many ways to achieve this.

The most straightforward is to store the token setup transaction with the token specifications and all subsequent token transactions. The token server 601 first checks whether the transaction is a token mint transaction by checking the public keys and the corresponding signatures in the input. If not, the token server 601 checks whether the inputs of a blockchain transaction are from some historical token transactions. If the check passes, then the token server 601 can start to validate the token transaction as defined below.

Note that the double spending check will be provided by the blockchain nodes and is optional for a token client. If a token server 601 delegates some checks on the validity of the transaction to blockchain nodes, they need to wait for a confirmation of the validity from the network. Therefore, we have the second requirement in the definition.

It is also possible to replace signature verification with format checking, which can be more efficient to implement. The idea is to ensure that when a public key is given in the input, a corresponding signature is also present, and delegate the signature verification to blockchain nodes. This can be achieved if the locking script is a standard P2PKH and the unlocking script in the input contains only one public key and one signature. We may allow other common scripts, and we can fall back to signature validation if the script is in question.

### Token Blocks

Regarding the structure of the stored data on a token server 601, we can mimic the blockchain system and introduce the concept of token blocks. This will enable us to introduce the concept of a token light client 602a in the next section. An example of a definition for a token block is given below.

### Definition—Token Block

A token block comprises a block header and a list of valid token transaction. The block header may contain some or all of the following fields, where
1. version indicates which token system this block belongs to,
2. previous block header hash is the double SHA256 value of previous token block header, empty for the genesis token block,
3. Merkle root is calculated on the token transactions in that token block,
4. Bitcoin block height indicates which Bitcoin block all the token transactions are from, and
5. transaction count indicates the total number of token transactions that are included in the token block.

A list of digital signatures can be added to each token block to indicate that each signer has verified the validity of the block, where a token block is valid if
1. all transactions are token valid,
2. all transactions are coming from the blockchain block that is specified by the blockchain block height,
3. it contains the hash value of the previous token block header,
4. the Merkle root of token transactions are correctly calculated, and
5. the transaction count is correct.

A token block is constructed a token server 601 as soon as a new blockchain block is published. For example, given a newly published blockchain block:

| | |
|---|---|
| Block Version | 0x00000001 |
| Prev_Block | 000000000000000000123456789912345678fe123456786cc1234123488d3f0c7 |
| Merkle_Root | 1234567891234567814159265359143c203141592653598a63814159265359 |
| Timestamp | 2021-02-04 10:50:50 utc |
| Difficulty_Bits | 18027387 |
| Nonce | 3141592653 |
| Tx_Count | 718281 |
| Txs | TxID₁, TxID₂, . . . , TxID₇₁₈₂₈₁ |

The token server 601 constructs the token block as the following:

| | |
|---|---|
| Version | Alice's GBP Token |
| Prev_Block | Double SHA256 of pervious token |
| | block header |
| Merkle_Root | MRₜₒₖₑₙ |
| Bitcoin_Block_Height | 672038 |
| Tx_Count | 4 |
| Txs | TxID₁, TxID₂, TxID₃, TxID₄ |
| Signatures | <sig><PK> |

1. We use the version field to indicate which token system the block belongs to.
2. The previous block hash will be the hash value of the previous block header. Note that There is no proof of work required here.
3. The Merkle root is calculated from the transactions that are included in the token block. An alternative is to use the Bitcoin Merkle root.
4. We use a new field called Bitcoin block height to indicate to which Bitcoin block all the token transactions belong.
5. The transaction count indicates how many transactions there are in the token block.
6. The full list of transactions is listed in the transactions field.
7. The signature field allows entities to add digital signatures that sign the block header. It can be a signature from the token issuer or a delegator. A signature should only be added after the token block is verified successfully.

Note that the token block header comprises the first 5 fields in the token block.

For each blockchain block, there can only be a maximum of one token block, and it is not possible for a token block to include a set of transactions that are coming from two different blockchain blocks.

There is no proof of work required for the token system. However, as all information about the token system can be derived from the blockchain ledger, the security of the token system is inherited from the blockchain system. The signatures added to the block provides a shortcut for token block validations. However, if users do not trust the signers, they can still validate the block independently. All information required to validate the token block is public available on the blockchain ledger. On the other hand, given the token block can be verified publicly, the signers are incentivised not to sign invalid token blocks.

A common concern would be orphan blocks, which occurs rarely from time to time. The token system is indeed subject to reorgs as the blockchain system. When a valid block or blocks is orphaned due to the presence of another longer chain that has more proof of work, all transactions that are in the block or blocks and not in the other longer chain will return to their unpublished status. The same applies to the token status. However, as in many cases, honest users and honest blockchain nodes will not be affected by reorgs as transactions on competing chains would be identical. For the token issuer, they need to make sure that the token server 601 who maintains their token system are connected to the majority of the network in order to have an accurate up-to-date view on their token system.

To optimise token validation, we can try to minimise the storage for token transactions and improve the efficiency in look ups. As a counterpart to Bitcoin light client, we introduce token light client 602a.

### Token Light Client

A token light client 602a is a token client that keeps
1. the token setup transaction,
2. the token block headers,
3. the token transactions in transaction IDs, and
4. the token value and the index of each output for each stored transaction ID.

The last two items can be concatenated into a string of the form TxID∥index∥value. The token light client 602a is capable of token transaction validation and token block construction.

When a token transaction is sent to the token light client 602a, it performs the following steps:
1. Check whether the token transaction is a mint transaction by comparing the public keys in its inputs with the public keys on the token specification.
2. If not, for each input, check whether the referenced outpoint matches a token outpoint stored locally.
3. If there is a match, identify all token outputs and check the total value of the token inputs is equal to (or greater than) the total value of the token outputs.

If the check passes, the token light client 602a saves the transaction as TxID∥index∥value∥flag for each of its token outputs. The flag indicates whether the corresponding transaction output (TxID∥index) is spent or unspent. Then the token transaction is sent to the blockchain network for further checks.

When the token light client 602a gets a confirmation from a blockchain node that the transaction is valid or accepted, the token light client 602a can include the transaction in the next token block. When a new blockchain block is published, the token light client 602a can construct the corresponding token block. Note that there is no need to have the full transaction data to construct the token block. It is enough to just have transaction IDs. Moreover, there is no proof of work required to construct the block. It might be sensible to double check everything is correctly computed and recorded. The token block can be finalised by having a signature from the token issuer.

### Token UTXO Client

We can improve the token system more by observing that spent token transactions or token outpoints may not have to be stored. In this section, we keep the token server 601 as described above and introduce the idea of a token UTXO client 602b. The token UTXO client 602b is responsible for tracking all unspent token outpoints, which will improve the efficiency in token transaction identification and validation. If there is anything goes wrong, the token system can always fall back to the token server 601.

### Definition—Token UTXO Snapshot

A token UTXO snapshot comprises a snapshot header and a set of outpoints. A snapshot header contains 5 fields, where
1. version indicates which token chain this snapshot belongs to,
2. previous snapshot header hash is the double SHA256 value of previous token snapshot header,
3. Merkle root is calculated on all the outpoints in the token UTXO set,
4. Bitcoin block height indicates up to which Bitcoin block the token UTXO set is derived,
5. outpoints count indicates the total number of outpoints that are in the token UTXO set.

A token server 601 and/or the token UTXO client 602b can construct and keep a list of the token UTXO snapshots. An example is given below:

| | |
|---|---|
| Version | Alice's GBP Token |
| Prev_Block | Double SHA256 of pervious token |
| | snapshot header |
| Merkle_Root | MR_{token-UTXO} |
| Bitcoin_Block_Height | 672038 |
| UTXO_Count | 4 |
| UTXO_set | TxID₁\|\|0, TxID₁\|\|1, TxID₂\|\|0, TxID₃\|\|1 |
| Signatures | <sig><PK> |

The advantage of this solution is that as a token client, it can choose to store only the latest token UTXO snapshot as it contains all the information the token client needs to verify token transactions and construct the next token UTXO snapshot. When receiving a blockchain transaction, the token client only needs to look up the outpoints in the input and check whether they are in the latest token UTXO set. If they are, then they are valid token inputs. Note that, the token client does not check the double-spending condition. This check is done by the blockchain nodes. This is one of the main advantages of a UTXO-based token system.

The downside is that if the latest token UTXO snapshot is corrupted, the token UTXO client 602b must retrieve the last token UTXO snapshot that is available and subsequent blockchain blocks or token blocks then derive the latest snapshot block by block. In this case, the token sever will a trusted source for the required information.

To mitigate the potential risk of losing the latest UTXO snapshot further, token issuers can choose to have more than one token servers and a few token UTXO clients to maintain their token systems. If one token UTXO client 602b fails, other UTXO clients can provide the information for speedy recovery while keeping the token system running uninterrupted.

FIG. 6 shows an example of token network. To summarise, the token network may comprise some or all of:
a token server 601 that stores all token related transactions and structure them in blocks,
one or more token light clients 602a that stores all token outpoints and their corresponding values, and
one or more token UTXO clients 602b that stores all unspent token outpoints and their corresponding values.

All of them are capable of validating token transactions and creating check points (e.g. token blocks or token UTXO snapshots) to improve efficiency.

### Improvements to Token Verification

As explained above, to check whether a blockchain transaction is a token transaction, one can trace back to a mint transaction via the transaction chain. However, this may be difficult to do when the system is at scale because the increasing length of token's history chain over time results in a growth of required resources for the tracing and comparison operations. The following techniques can be used in addition or, preferably, as alternatives to the “token blocks” and “token light client” approaches discussed herein.

With reference to FIG. 7, embodiments of the disclosure provide mechanisms which avoid the need to trace all the way back to the minting transaction. Instead, at least one token verification/certification element is inserted into the token transaction chain at some point following the mint transaction(s), so that a verifying entity 701 only needs to trace back from a given or current token transaction (such as the target token transaction as above) to an identifiable certification element. In accordance with one approach, each token transaction in the chain could be stamped by the issuer to authenticate the token(s) it carries. However, this could require significant resources on behalf of the issuer 702 and the verifying/using party 701, 703. In a preferred embodiment, therefore, the chain is periodically stamped with a certification element so that the need to traverse the chain back to its origin is alleviated along with the need to stamp every transaction in the chain. Another advantage of periodic stamping is that it enables use of offline token transactions. This can be highly advantageous in circumstances where connectivity over the internet and other networks is not available. For example, transactions and transfers made on an aeroplane or in geographic locations where connectivity is not possible. Such offline transfers are not possible with prior art approaches where the issuer is required to stamp every transaction.

The token certification element certifies that the at least one token provided in the token transaction was generated by or on behalf of the issuer 702. In some embodiments, the token transaction comprises one token, while in other it may comprise more than one token. From hereon, we refer to a singular token for ease of reference. Similarly, one or more than one certification element may be provided in a token transaction, and the token(s), token transaction and/or certification element(s) may be issued by one or more issuers using one or more mint transactions. We refer, though, for convenience, to these in the singular.

In some embodiments, the at least one token certification element is provided in the token transaction in response to a request or instruction. The request or instruction could originate from a token user 703, or an intended recipient of the token, or the issuer 702 or their representative, or some other party. Additionally, or alternatively, the certification element can be provided in the token transaction in accordance with at least one predetermined rule or criteria. Performance or evaluation of the rule/criteria can be automated and performed by a software-based component which may be executed by or on behalf of a validating entity 701. The at least one pre-determined rule or criteria could, for example, specify a threshold, interval or metric for identifying or selecting the transaction within the chain of token transactions so that the certification element can then be inserted into it by the issuer or an entity that is authorised to do so by the issuer 702.

The certification element comprises some form of evidence that the token is genuine or authentic, in that it has been legitimately formed by the issuer(s) 702. In this way, it legitimizes the token(s) in the token transaction and its presence in the transaction serves as a substitute for the mint transaction during a verification process. Thus, the certification element can take any suitable form that fulfils this role, such as, for example, proof of a secret known to or associated with the issuer; and/or cryptographic data. Cryptographic data could comprise a cryptographic key, a signature, a digitally signed message or other cryptographic element associated with the issuer or a party authorised by or associated with the issuer. Essentially, the certification element provides evidence that can be trusted as belonging or known only to the issuer/authorised party.

The certification element can be provided in the at least one token transaction in a variety of locations and/or formats. For example, it could be inserted into the transaction at a location following an instruction or code, for example after an OP_RETURN other instruction. It could be provided elsewhere in a script, and/or provided as metadata.

As the chain of token transactions grows over time through usage and transmission of the token(s), the same or a different certification element is provided in a new token transaction when it is added to the ledger 150. Thus, the chain may comprise multiple certification elements which are provided in contiguous token transactions or, preferably, at spaced intervals. When the certified token transactions are spaced apart, the interval between them may be defined by the afore-mentioned rule or criteria. For example, a certification element may be provided every x number of token transactions on the ledger 150. Other metrics for determining the interval may be readily devised and implemented. Alternatively, the certification element may be inserted into the chain on a random or ad hoc basis, or (as previously mentioned) in response to a triggering even such as a request, instruction or monitored state. The monitored state may relate to an entity, resource or condition which is located on or off the blockchain.

The certification element can be utilised by any entity or party that needs to validate or certify that the token(s) in a given token transaction were, indeed, issued by the issuer 702. This could, for example, be the validating entity 701 or a user 703 or a token client 602b. Traditionally, such a party needs to establish the token's provenance by tracing the transaction chain back to the mint transaction to verify that it has, indeed, been generated by the issuing source, but embodiments of the disclosure enable the verifying party to traverse the chain of token transactions only from the token transaction to a previous token transaction that comprises a token certification element. This saves a significant amount of energy, time and processing resource.

Embodiments of the disclosure may comprise features relating to melting and re-minting of the token. These features may be provided in addition to, or alongside and in conjunction with, the validation technique described above. In accordance with such embodiments, and as above, the at least one token is provided in a token transaction on a blockchain (150) and is generated in an original mint transaction by or on behalf of an issuing party 702. Advantageously, the token is melted and reminted. In some embodiments, this may be performed on an ad hoc random or pseudo-random basis, although in a preferred embodiment it is performed when a pre-determined threshold, limit or specified value has been reached. Melting, in accordance with one form of wording, can be described as modifying the token or the token transaction, or performing some off-chain operation such that the token is no longer deemed valid or certified/authenticated by the issuer 702. Re-minting, in accordance with one form of wording, can be described as modifying the token or the token transaction, or performing some off-chain operation such that the token remains valid or certified/authenticated by the issuer 702 but performance of the modification or other operation can be verified. The token remains valid and approved by the issuer 702 but its validity is re-incarnated in a different form. It is no longer valid in its previous form.

The melting operation can comprise providing an identification element, marker or other portion of data to indicate that the token is no longer valid. The specific mechanism used for melting and re-minting will depend upon the implementation involved, but in one example embodiment, it can comprise providing an identification element, marker or other portion of data to indicate that the token is no longer valid. Similarly, re-minting can be performed in a variety of ways, including providing an identification element, marker or other portion of data to indicate that the token is valid but in a modified form.

The identification element can take a variety of forms, including an identifier and/or cryptographic data such as, for example, a cryptographic key, signature, signed message etc. Preferably, the identification element is associated with the at least one issuer or a party authorised by the at least one issuer, and serves as approval or issuance by the issuer. The identification element can be provided in a blockchain transaction, preferably in the token transaction, or in a storage resource provided off the blockchain.

The pre-determined threshold, limit or specified value can be monitored by the issuer or some other party, to determine when it has been reached. This may involve comparing it against a supplied value. When the issuer or other party determines that the threshold has been reached or exceed, the melt and/or re-mint operations can be performed. This provides the advantage of reducing required resources and improving efficiency as explained above. In some embodiments, the pre-determined threshold, limit or specified value is determined by or on behalf of the issuer or a validating entity (701).

### CONCLUSION

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However, it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In non-preferred embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

1. A blockchain-implemented method of endorsing or attesting an authenticity of at least one token provided in a token transaction that is an element in a chain of token transactions originating from at least one minting transaction used by or on behalf of at least one issuer to generate the at least one token;
wherein the method comprises:
providing, in the token transaction, at least one token certification element which certifies that the at least one token was generated by or on behalf of the at least one issuer, wherein the at least one token certification element is provided in the token transaction in accordance with at least one predetermined rule or criteria, wherein the at least one predetermined rule or criteria specifies a threshold, interval or metric for identifying or selecting the transaction within the chain of token transactions.

2-3. (canceled)

4. The method of claim 1, wherein the at least one certification element is provided in the token transaction by the at least one issuer or a party authorised by the at least one issuer.

5. The method of claim 1, wherein the at least one certification element comprises:
proof of a secret known to or associated with the at least one issuer; and/or cryptographic data, preferably wherein the cryptographic data is or comprises a cryptographic key, signature, digitally signed message or other cryptographic element associated with the at least one issuer or a party authorised by the at least one issuer.

6. The method of claim 1, wherein the at least one certification element is provided in the token transaction:
in a script of the transaction, wherein the script is associated with an output of the transaction; or as metadata in a script of an output; or
following an instruction or code which renders the token transaction unspendable.

7. The method of claim 1, and comprising the step of providing the same or a different certification element in at least one further token transaction in the chain of token transactions.

8. A blockchain-implemented method of validating at least one token provided in a token transaction on a blockchain that is an element in a chain of token transactions originating from at least one minting transaction used by, or on behalf of, an issuer to generate the token, wherein the method comprises:
inspecting the token transaction to determine whether it comprises at least one token certification element which certifies that the token was generated by or on behalf of the issuer; and/or
traversing the chain of token transactions on the blockchain from the token transaction until a previous token transaction is identified in the chain which comprises at least one token certification element which certifies that the token was generated by or on behalf of the issuer,
wherein the at least one token certification element is provided in the token transaction in accordance with at least one predetermined rule or criteria, wherein the at least one predetermined rule or criteria specifies a threshold, interval or metric for identifying or selecting the transaction within the chain of token transactions.

9. The method of claim 8, wherein the step of traversing the chain of token transactions is performed if, and only if, the token transaction does not comprise the at least one token certification element.

10. The method of claim 8, wherein the step of traversing the chain of token transactions comprises:
inspecting a token transaction in the chain to determine whether it comprises the at least one token certification element.

11. The method of claim 8 wherein the at least one certification element comprises:
proof of a secret known to, or associated with, the at least one issuer; and/or cryptographic data, preferably wherein the cryptographic data is or comprises a cryptographic key, signature, digitally signed message or other cryptographic element associated with the at least one issuer or a party authorised by the at least one issuer.

12. A blockchain-implemented method of issuing at least one token provided in a token transaction on a blockchain, comprising:
melting and reminting the token when a predetermined threshold, limit or specified value has been reached.

13. The method of claim 12, wherein:
the token transaction is traceable on the blockchain to at least one mint transaction issued by or on behalf of at least one issuer.

14. The method of claim 13, wherein:
melting the at least one token comprises providing an identification element, marker or other portion of data to indicate that the token is no longer valid; and/or
re-minting the token comprises providing an identification element, marker or other portion of data to indicate that the token is valid but in a modified form.

15. The method of claim 14, wherein
the identification element is:
an identifier and/or cryptographic data; and/or
associated with the at least one issuer or a party authorised by the at least one issuer; and/or provided in a blockchain transaction, in the token transaction or in a storage resource provided off the blockchain.

16. The method of claim 12, and further comprising:
assessing whether the predetermined threshold, limit or specified value has been reached by performing a comparison of a supplied value against the threshold, limit or specified value.

17. The method of claim 13, wherein:
the predetermined threshold, limit or specified value is determined by the at least one issuer or a party authorised by the at least one issuer, a user or a validating entity.

18-19. (canceled)
